(19) United States
(12) Patent Application Publication
(10) Pub. No.: US 2015/0369766 A1
(43) Pub. Date: Dec. 24, 2015

(54) SENSOR DEVICE FOR SENSING A HUMIDITY OF A FLUID MEDIUM

(71) Applicant: Robert Bosch GmbH, Stuttgart (DE)

(72) Inventors: Karl WENZEL, Stuttgart (DE); Metin GUERER, Ludwigsburg (DE)

(21) Appl. No.: 14/701,776

(22) Filed: May 1, 2015

(30) Foreign Application Priority Data
Jun. 23, 2014 (DE) 10 2014 211 934.0

(51) Int. Cl. G01N 25/56

(52) U.S. Cl. CPC G01N 25/56; G01K 2013/024

(57) ABSTRACT

A sensor device includes a housing in which there is a measuring space, a humidity module at least partially disposed within the measuring space and that includes a humidity sensor element for sensing humidity of a fluid medium in the measuring space, and a first temperature sensor for sensing a temperature of the fluid medium in the measuring space, and an evaluation unit that performs a method of outputting a first temperature signal of the first temperature sensor that indicates the temperature of the fluid medium in the measuring space, correcting a humidity signal of the humidity sensor element using a second temperature signal, which indicates a temperature of the fluid medium in a region of the sensor device that is thermally decoupled from the evaluation unit, and outputting the corrected humidity signal indicating the humidity of the fluid medium in the measuring space.

### BACKGROUND

Numerous methods and devices for ascertaining properties of fluid media, such as liquids or gases, are known from the related art. The properties may basically be any physically and/or chemically measurable properties that qualify or quantify the fluid medium, especially the relative or absolute humidity of a gas or gas mixture. It is generally known that humidity sensors are used in the intake duct or exhaust duct of internal combustion engines. To regulate the combustion efficiency, for example, especially for a residue-free and clean combustion, it is important to ascertain, among other things, the humidity of the supplied fresh air in order to be able to set the correspondingly desired mixture ratio between fresh air and recirculated exhaust gas, for example, and to subsequently ascertain a fuel quantity required for the predefined mixing in the cylinder of the internal combustion engine. The information about the humidity of the supplied ambient air as well as the exhaust gas is used by the engine control unit for a multitude of regulated processes.

### SUMMARY

Despite the numerous advantages of the previously known sensor devices for recording a humidity of the fluid medium, there is still room for improvement. For example, the relative humidity depends on the ambient temperature, but, if the ambient temperature rises with moisture being added or removed, the measured relative humidity will drop, and vice versa. In the known sensor devices, the sensor element for sensing the humidity is not necessarily thermally decoupled from the electronics of the sensor device, and therefore it can happen that, due to the intrinsic heating of the electronics, heat reaches the sensor element and thereby falsifies its measured value. However, mechanical decoupling is possible only in those locations where space is actually available. If the design of the sensor device is to take up the least space possible, as is the case in hot-film air-mass meters, for example, mechanical decoupling is normally impossible. The result then is a falsified air humidity signal.

Embodiments of the present invention provide a sensor device for sensing a humidity of a fluid medium, which at least for the most part is able to avoid the disadvantages of known sensor devices and in which the measuring accuracy of the relative humidity is improved, in particular.

According to an example embodiment of the present invention, the sensor device for sensing a humidity of a fluid medium includes at least one housing provided with a measuring chamber. A housing within the framework of the present invention generally denotes a device that encloses at least one interior space and provides a protective function for one or more component(s) of the sensor device that are accommodated in the at least one interior space. In particular, the housing can be developed to provide a mechanical protective function. As an alternative or in addition, for example, protective functions with regard to moisture, mechanical loading during the installation of the sensor device, thermal protective functions, or other protective functions or combinations of said and/or other protective functions can be provided. The housing can preferably be designed to ensure a protective effect at least with respect to mechanical loads. For example, the housing can be at least partially made from a stiff material, which, given normal forces, such as the usual screw-fitting forces, for instance, does not undergo any deformation when the housing is fixed in place in a flow space of a fluid medium. The housing can be wholly or partially made from a metallic material and/or a plastic material, for example.

In addition, the sensor device includes at least one humidity module, which is provided with at least one sensor element for sensing the humidity of the fluid medium in a measuring space, as well as a first temperature sensor for sensing a temperature of the fluid medium in the measuring space. The humidity module is at least partially situated in the measuring space of the housing.

Within the framework of the present invention, a sensor element for sensing the humidity of the fluid medium is an element that is suitable for ascertaining the humidity of a fluid medium and preferably of gases. Humidity or moistness is the portion of water vapor in the fluid mixture and especially the gas mixture in a certain volume, such as a space, for instance. The humidity or moistness can be recorded as relative air humidity, expressed as a percentage, and indicates the ratio of the current water vapor content in relation to the maximally possible water vapor content of the fluid mixture for the current temperature and the current pressure. As an alternative, the humidity can be sensed as absolute humidity, as mass of the water vapor in a specific volume, i.e., its density or concentration. Common are also the expressions specific humidity and mixture ratio. Here, the mass of the moisture in relation to the total mass or in relation to the mass of the dry air is indicated. This is usually expressed in [g/kg]. The measuring principles used for acquiring the humidity are described, for instance, in Konrad Reif, Sensoren im Kraftfahrzeug, 1st edition, 2010, pp. 98-100.

In addition, the sensor device includes an evaluation unit. The evaluation unit is set up to output a first temperature signal, which indicates the temperature of the fluid medium in the measuring space, and to output a humidity signal, which indicates the humidity of the fluid medium in the measuring space. Moreover, the evaluation unit is developed to correct the humidity signal with the aid of a second temperature signal, which indicates a temperature of the fluid medium in a region of the sensor device that is thermally decoupled from at least the evaluation unit.

Within the scope of the present invention, an evaluation unit generally means a preferably electronic control unit, especially control electronics and/or evaluation electronics of the sensor device, or a part of such control electronics and/or evaluation electronics. The control electronics and/or evaluation electronics can be developed to actuate at least one functionality of the sensor device and/or to sense and/or process at least one signal generated by the sensor device, especially with regard to obtaining information about the humidity of the fluid medium. This evaluation may furthermore take place within the framework of signal conditioning and a partial pre-analysis or otherwise include a complete analysis.

Within the framework of the present invention, a region of the sensor device that is thermally decoupled from the evaluation unit is a region within the sensor device that is not subject to warming, or subject to only negligible warming, by electronic or electric components of the sensor device.

The evaluation unit in particular is designed to correct the relative humidity signal with the aid of a difference between the first temperature signal and the second temperature signal. For example, the second temperature signal is subtracted from the first temperature signal. The difference determined in this manner can be used for ascertaining a corrected saturation vapor pressure of the fluid medium in the measuring space.

Within the framework of the present invention, a saturation vapor pressure is the particular pressure of a fluid medium at which the gaseous aggregate state is in equilibrium with the fluid or solid aggregate state. The saturation vapor pressure depends on the temperature. In the equilibrium weight state, the vaporization or sublimation of the fluid or the solid matter is equal to the condensation or resublimation of the gas in quantitative terms.

The evaluation unit is also developed to correct the humidity signal with the aid of the corrected saturation vapor pressure.

In addition, the sensor device can include a second temperature sensor for ascertaining the second temperature signal. As an alternative, the evaluation unit can include a memory from which the second temperature signal can be called up. The second temperature signal in particular is a function of the operating conditions of the sensor device.

Furthermore, an example embodiment of the present invention provides a method for correcting a humidity signal from a sensor device for sensing the humidity of a fluid medium. A sensor module includes at least one humidity module. The humidity module includes at least one sensor element for sensing the humidity of the fluid medium in a measuring space, and a first temperature sensor for sensing a temperature of the fluid medium in the measuring space. The method includes ascertaining a first temperature signal, which indicates the temperature of the fluid medium in the measuring space; ascertaining a humidity signal, which indicates the humidity of dampness of the fluid medium in the measuring space; and correcting the humidity signal with the aid of a second temperature signal, which indicates a temperature of the fluid medium in a thermally decoupled region of the sensor device.

The humidity signal is able to be corrected using a difference between the first temperature signal and the second temperature signal. For example, the second temperature signal is subtracted from the first temperature signal. With the aid of the difference, it is possible to ascertain a corrected saturation vapor pressure of the fluid medium in the measuring space. The humidity signal can be corrected with the aid of the corrected saturation vapor pressure. The second temperature signal can be ascertained by a second temperature sensor. As an alternative, the second temperature is an empirically determined signal.

Within the framework of the present invention, an empirically determined signal is a signal that is ascertained on the basis of laboratory experiments under various conditions and stored in a memory of an evaluation unit. The signal ascertained in this manner characterizes intrinsic heating of the electronics of the sensor device. For example, the value of the second temperature signal is analyzed on a continuous basis. While the sensor device is operating, a micro control then uses the currently measured humidity signal and the currently measured temperature signal(s) to calculate a compensated air humidity and a compensated temperature signal. In so doing, the second temperature value or the empirically ascertained value is deducted from the temperature signal. An additional temperature signal is produced in the process. The saturation vapor pressure is calculated for both temperature signals. Here, it is assumed that the saturation vapor pressure does not change and the measurement takes place approximately at sea level. If it is possible to utilize an air mass signal in addition, then this signal will be used as well for calculating the intrinsic heating of the sensor device, for an even more precise measurement.

Further optional details and features of the present invention result from the following description of preferred example embodiments, which are schematically illustrated in the figure.

### BRIEF DESCRIPTION OF THE DRAWING

FIG. 1 shows a cross-sectional view of a cut-away of a sensor device for detecting a humidity of a fluid medium, according to an example embodiment of the present invention.

### DETAILED DESCRIPTION

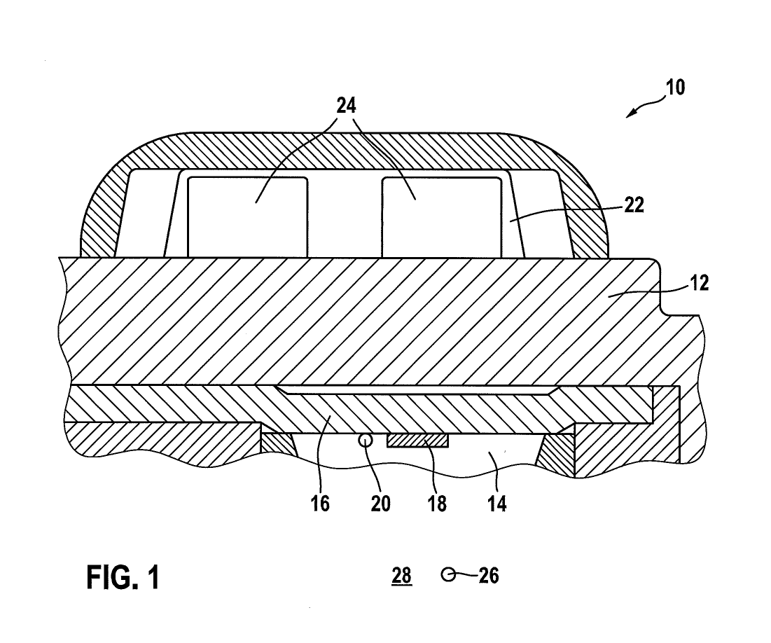

FIG. 1 shows a cross-sectional view of a cut-away of a sensor device 10 for sensing a humidity of a fluid medium. Sensor device 10 includes a housing 12, in which there is a measuring space 14. Sensor device 10 includes a humidity module 16, which includes at least one sensor element 18 for sensing the humidity of the fluid medium in measuring space 14. Humidity module 16 also includes a first temperature sensor 20 for sensing a temperature of the fluid medium in measuring space 14.

Housing 12 includes an electronics space 22, in which an evaluation unit 24 is located. Humidity module 16 is at least partially disposed within electronics space 22, together with sensor element 18.

In an example embodiment, sensor device 10 also includes a second temperature sensor 26 situated in a region 28 of sensor device 10, which is thermally decoupled from evaluation unit 24. A thermally decoupled region 28 is a region that is thermally unaffected or only negligibly affected by intrinsic warming of evaluation unit 24 and possibly additional electronic components of sensor device 10 while sensor device 10 is in operation, and in this way senses an actual temperature of the fluid medium, i.e., a temperature that is not affected by heat generated by electronics components of sensor device 10.

Evaluation unit 24 uses a second temperature signal, for example obtained via temperature sensor 26, to correct the relative humidity signal. More precisely, evaluation unit 24 corrects the humidity signal with the aid of a difference between a first temperature signal, which is ascertained by first temperature sensor 20, and the second temperature signal, which is ascertained by second temperature sensor 26. In particular, the second temperature signal is subtracted from the first temperature signal. The temperature difference ascertained in this manner is used for ascertaining a corrected saturation vapor pressure in measuring space 14. The calculation of the saturation vapor pressure can be performed on the basis of the Magnus formula for the ascertainment of a saturation vapor pressure for water vapor across level water surfaces. The formula reads as follows:

$$Ew ( t ) = 6.112 hPa * exp ( \frac{17.62 * t}{243.12 ° C . + t} )$$

where E_{w} is the saturation vapor pressure for water, and t is the temperature of the fluid medium.

Using the corrected saturation vapor pressure, evaluation unit 24 corrects the humidity signal. The corrected humidity is calculated in the following manner:

$$ρ corr = \frac{Euncorrected}{Ecorrected} * ρ measured$$

In an alternative example embodiment, in which no second temperature sensor is provided, for instance because this is impossible for reasons of space, evaluation unit 24 can include a memory (not shown). To rid the humidity signal of warming of evaluation unit 24 and possibly of further electronic components, a second temperature signal is ascertained which is not subject to the intrinsic warming of evaluation unit 24. For example, this signal is determined with the aid of laboratory experiments and indicates how high the intrinsic warming of the evaluation unit is under different conditions. The values ascertained in this manner are stored in the memory. The correction of the air humidity can then take place in the manner described earlier.

What is claimed is:

1. A sensor device for sensing a humidity of a fluid medium, the sensor device comprising:
a housing in which there is a measuring space;
a humidity module that is at least partially disposed within the measuring space and that includes a humidity sensor element for sensing the humidity of the fluid medium in the measuring space, and a first temperature sensor for sensing a temperature of the fluid medium in the measuring space; and
an evaluation unit configured to:
output a first temperature signal of the first temperature sensor that indicates the temperature of the fluid medium in the measuring space;
correct a humidity signal of the humidity sensor element using a second temperature signal, which indicates a temperature of the fluid medium in a region of the sensor device that is thermally decoupled from the evaluation unit; and
output the corrected humidity signal indicating the humidity of the fluid medium in the measuring space.

2. The sensor device of claim 1, wherein the evaluation unit is configured for the correction of the humidity signal to be performed based on a difference between the first temperature signal and the second temperature signal.

3. The sensor device of claim 2, wherein the evaluation unit is configured to ascertain a corrected saturation vapor pressure of the fluid medium in the measuring space based on the difference.

4. The sensor device of claim 3, wherein the evaluation device is configured for the correction to be performed based on the ascertained corrected saturation vapor pressure.

5. The sensor device of claim 1, further comprising a second temperature sensor for ascertaining the second temperature signal.

6. The sensor device of claim 1, further comprising a memory from which the second temperature signal is retrievable by the evaluation unit.

7. A method of a sensor device that is configured for sensing a humidity of a fluid medium, the sensor device including an evaluation unit and a humidity module that includes (a) a humidity sensor element for sensing the humidity of the fluid medium in a measuring space, and (b) a first temperature sensor for sensing a temperature of the fluid medium in the measuring space, the method comprising:
obtaining, by the evaluation unit and from the first temperature sensor, a first temperature signal, which indicates the temperature of the fluid medium in the measuring space;
obtaining, by the evaluation unit and from the humidity sensor element, a humidity signal, which indicates the humidity of the fluid medium in the measuring space;
correcting, by the evaluation unit, the humidity signal based on a second temperature signal, which indicates a temperature of the fluid medium in a region of the sensor device that is thermally decoupled from the evaluation unit; and
outputting, by the evaluation unit, the first temperature signal and the corrected humidity signal.

8. The method of claim 7, wherein the correction is based on a difference between the first temperature signal and the second temperature signal.

9. The method of claim 8, further comprising ascertaining a corrected saturation vapor pressure of the fluid medium in the measuring space based on the difference.

10. The method of claim 9, wherein the correction is based on the ascertained corrected saturation vapor pressure.

11. The method of claim 7, wherein the second temperature signal is obtained from a second temperature sensor.

12. The method of claim 7, wherein the second temperature signal is retrieved by the evaluation unit from a memory.
